(19) United States
(12) Patent Application Publication
(10) Pub. No.: US 2011/0051421 A1
(43) Pub. Date: Mar. 3, 2011

(54) WATERPROOF LED BEACON LIGHT

(75) Inventor: Ah Leh Chew, Kuala Lumpur (MY)

(73) Assignee: AVIALITE SDN BHD, Selangor Darul Ehsan (MY)

(21) Appl. No.: 12/990,022

(22) PCT Filed: Apr. 28, 2009
(86) PCT No.: PCT/MY09/00057

§ 371 Date: Oct. 28, 2010

(30) Foreign Application Priority Data
Apr. 30, 2008 (MY) PI 20081370

(51) Int. Cl. F21S 4/00

(52) U.S. Cl. 362/249.06

(57) ABSTRACT

The present invention relates to a beacon light (100) for aviation obstacle warning comprising an elongated body portion formed into a hollow tube (19), a plurality of light emitting diodes (LEDs) (10) mounted on the outer surface of the hollow tube (19) and electrically connected together to form a substantially cylindrical array of LEDs (10), characterized in that a plurality of grooves (21) are formed axially on the outer surface of the hollow tube for arranging the array of LEDs (10) in a substantially cylindrical and orderly manner, and the hollow tube and the LEDs (10) being encapsulated with sealing composition (11), wherein at least a part of the lens body of the LEDs (10) protrudes out from the surface of the encapsulation to allow the direct emission of light. The LEDs (10) are affixed along an elongate conductor set within the grooves (21) and the surface of the body portion. The beacon light (100) which is very compact, light weight for use high up on communications towers and in an around airports, etc. The clear portion of the LED lens to project the light directly outwards 360 degrees horizontally and with a vertical beam width of 15-35 degrees. This eliminates the need for a dome or covers over the LEDs that cut down effective light output. This construction further improves heat conduction and cooling from direct convection of air. It is particularly good for keeping out moisture from causing deterioration of the electrical and electronic circuits in the light (100) in hot and humid tropical climates and for long term operation of the light (100).

### FIELD OF INVENTION

The present invention relates to waterproof beacon lights which are suitable for the use of aviation obstacle warning. More particularly, it relates to an waterproof beacon light having a cluster of light emitting diodes (LEDs) arranged in a substantially cylindrical pattern and all its associated electrical and electronic circuits are hermetically sealed from moisture and water by an encapsulation method.

### BACKGROUND OF THE INVENTION

Light Emitting Diode (LED) beacon lights are high-intensity lighting devices that are mounted to tall structures and used as collision avoidance measures for flying aircraft. These LED beacon lights are required to have sufficient brightness in order to be visible for miles around the structure. Moreover, LED beacon lights are used as indicator lights on the edges of airport runways.

The use of LED signal light of known designs and configurations is known in the prior art. More specifically, the LED signal light of known designs and configurations previously devised and utilized for the purpose of signal light through known methods and apparatuses are known to consist basically of familiar, expected, and obvious structural configurations, notwithstanding the myriad of designs encompassed by the crowded prior art which has been developed for the fulfillment of countless objectives and requirements.

Example of U.S. Pat. No. 6,525,668 B1 issued to Jonh T. Petrick and relating to an LED array warning light system. This patent disclosed an LED array warning lighting system comprises a plurality of struts in a general conical configuration. Each strut has an upper and lower edge and an inner and an outer edge.

A plurality of light emitting diodes are affixed above one the other to an edge of each strut. A top disk with radial slots receives and is affixed to an upper edge of an associated strut. A bottom disk has radial slots which receives and is affixed to a lower edge of an associated strut. The disks are sized whereby the LED's are at an angle between 3 and 25 from the axis. A translucent dome cover is provided with an open top for the dissipation of heat.

A major problem with these devices is that in the case of the LED warning light system with a dome cover, there is by necessity of air space between the light system's dome cover and the LEDs. Allowance in the form of vent holes at the bottom must be made to permit the expansion and contraction of the air due to temperature changes. In hot and humid tropical climate of the tropics, the air inside the lighting system expands and flows out of the lighting system during hot day time. However during the night or at cooler temperatures the air inside the lighting system cover contracts and creates a partial vacuum that draws in the cool air from outside the lighting system. The cool outside air invariably contains moisture that may condense and accumulate to form water on the LEDs or drive electronic and may induce corrosion and turn them moldy after a few months or years.

While these devices fulfill their respective, particular objectives and requirement, the aforementioned patent does not describe lamp without a dome or cover or a lamp that can operate even when submerged under water. What is needed in the art is a hermetically sealed LED beacon light according to the present invention substantially departs from the conventional concepts and designs of the prior art, and in doing so provides a much improved ingress protection for the LED beacon light for its critical internal electrical and electronics control circuits. In addition the solidified sealing compound provides a much more rigid and robust LED beacon light with improved heat conduction, dissipation and compactness. These benefits make it possible to have a more compact and lighter weight LED beacon light for easier installation on tall towers and a more reliable long operating life LED beacon light due to total exclusion of moisture and water from the internal operational circuits.

### SUMMARY OF THE INVENTION

Accordingly, one object of the present invention is to provide a beacon light which can overcome the drawbacks in the background art. The present invention is a beacon light for aviation obstacle warning comprising an elongated body portion formed into a hollow tube; a plurality of light emitting diodes (LEDs) mounted on the outer surface of the hollow tube and electrically connected together to form a substantially cylindrical array of LEDs; characterized in that a plurality of grooves are formed axially on the outer surface of the hollow tube for arranging the array of LEDs in a substantially cylindrical and orderly manner; and the hollow tube and the LEDs being encapsulated with sealing composition, wherein at least a part of the lens body of the LEDs protrudes out from the surface of the encapsulation to allow the direct emission of light.

It is the object of the present invention to provide a beacon light which has improved ingress protection especially for wet and humid and hot tropical climates.

It is another object of the present invention is to provide a beacon light which is more compact and rigid to reduce wind loads when installed in tall towers, easy to install and robust to withstand vibration and shock during transport and handling to remote sites.

It is another object of the present invention is to provide to provide a beacon light that has good heat dissipation through conduction of the sealing compound and convection of air flow through light surface to keep the LEDs operating at close to ambient temperature to maintain a longer life-span of the LEDs.

To achieve the above and other objectives, the present invention set forth a beacon light which utilizes ultra high brightness light emitting diodes (LED) as the illumination source. A number of LEDs are connected in cluster in parallel and a number of clusters are in turn connected in series to form the complete LED beacon light. The LEDs subassembly is formed in such a way that it can be inserted into suitable flexible rubberized moulds for formation of the complete lamp and final encapsulation with epoxy based composition. To achieve a compact light structure the drive electronics together with the LEDs are assembled in a way with specialized light weight but firm polystyrene foam material for positioning of the LED units and holding the electrical and electronics drive control circuits.

The use of specially designed and shaped foam material to hold the LEDs and drive electronics as well as the associated rubberized mould to insert the LEDs and outer casting moulds of the present invention make it possible to have a fully encapsulated LED beacon light that is water-proofed and have the associated benefits of higher output efficiency without a cover or filter, more compact and light weight and good heat dissipation for longer life-span of the light.

The present invention consists of certain novel features and a combination of parts hereinafter fully described and illustrated in the accompanying drawings and particularly pointed out in the appended claims; it being understood that various changes in the details may be carried out without departing from the scope of the invention or sacrificing any of the advantages of the present invention.

### BRIEF DESCRIPTION OF THE DRAWINGS

FIG. 1 shows a side perspective view of beacon light of the present invention.

FIG. 2 shows a top perspective view of beacon light of the present invention.

FIG. 2a shows a cut away top view showing part of the LED units embedded in a sealing composition.

FIG. 3 shows a bottom perspective view with its mounting bolts of beacon light of the present invention.

FIG. 3a shows a cut away bottom view of beacon light showing the metal reinforcement anchor plate for the mounting bolts.

FIGS. 4 & 4a shows the beacon light in exploded view and the light weight, firm but flexible polystyrene core that is used to hold the AC transformer and position the LED units in 360 degree arc. The polystyrene tubular form core also serves to reduce the weight of the light as it reduces the amount of heavier sealing composition needed for formation of the product.

FIG. 5 shows the perspective view of a cluster of LEDs electrically connected together which are affixed along an elongate conductor in a rectangular sinusoidal wave form.

The present invention consists of certain novel features and a combination of parts hereinafter fully described and illustrated in the accompanying drawings and particularly pointed out in the appended claims; it being understood that various changes in the details may be without departing from the scope of the invention or sacrificing any of the advantages of the present invention.

### DETAILED DESCRIPTION OF THE INVENTION

Before describing in detail embodiments that are in accordance with the present invention, it should be observed that the embodiments are created for the waterproof LED beacon light that can be cast in one integral piece using suitable moulds. The drawing and descriptions show only those specific details that are pertinent to understanding the embodiments of the present invention so as not to obscure the disclosure with details that will be readily apparent to those of ordinary skill in the art having the benefits of the description herein.

The present invention relates to a beacon light (100) for aviation obstacle warning comprising an elongated body portion formed into a hollow tube, a plurality of light emitting diodes (LEDs) (10) mounted on the outer surface of the hollow tube and electrically connected together to form a substantially cylindrical array of LEDs (10), characterized in that a plurality of grooves are formed axially on the outer surface of the hollow tube for arranging the array of LEDs (10) in a substantially cylindrical and orderly manner, and the hollow tube and the LEDs (10) being encapsulated with sealing composition, wherein at least a part of the lens body of the LEDs (10) protrudes out from the surface of the encapsulation to allow the direct emission of light. The LEDs (10) are affixed along an elongate conductor set within the grooves and the surface of the body portion. Preferably, the elongate conductor is a copper wire and formed in a rectangular sinusoidal wave form.

One preferred embodiment of the present invention is illustrated in FIG. 1. The individual LEDs (10) extend outward from the outer surface of the hollow tube, so that a plurality of LEDs (10) project in substantially an cylindrical array. In this manner, initial flat elongated body portion, which is made of material such as polystyrene is used, the elongated body portion is being bent into the three-dimensional shape of the beacon light (100) such as the hollow tube. In one example, the beacon light (100) comprises 72 high brightness LEDs (10) arranged in six vertically adjacent rows. Each row may comprises 12 LEDs (10) separated by substantially 30 degrees angularly in the horizontal plane. Preferably, a substantially 15 degree angular offset is applied between adjacent rows. Thus, the beacon light (100) may have 24 LEDs (10) over 2 rows which can cover a 360 degree emission angle. Since the beacon light (100) have 6 rows, this arrangement may be repeated in the subsequent 4 rows. Preferably, about 6 mm of the lens body of the LEDs (10) protrudes out from the surface of the sealing composition (11). The LEDs (10) for this example have half power beam angle of 15 degrees. Other beam angles of say 30 degree can also be used with a different configuration. This substantially cylindrical array of LEDs (10) is well suited for beacon lights (100) on tops of the buildings, on trains, or ships, or for placement on the edge of the airport runways, among other uses. Of course, as mentioned above, the arrangement of LEDs (10) around the beacon light (100) may be modified to include more or less as desired, the present illustrated embodiments being merely for example. Still referring to the LED beacon lights (100) as shown in FIG. 1 for installation on towers or other relevant sites. The LEDs (10) are integral with the beacon light (100) body and part of the LEDs' (10) bodies are embedded inside the encapsulating composition 11, leaving part of the clear lens of the LEDs (10) exposed. The LEDs (10) chosen are made from clear hard material that is resistant to UV (ultra violet radiation). The conventional LED lights of prior art uses a clear or coloured dome cover to protect the LEDs (10) and the associated drive circuits from dust and water. This invention eliminates the need for a domed cover as the encapsulating composition provides the necessary dust and water ingress protection. The light output emits directly from the LEDs (10) without going through another cover medium which tends to reduce the effective output of the LEDs (10) and increases the external physical dimensions of the light (100).

In this invention the whole light (100) is cast as an integral piece with all vital electrical and electronic parts completely sealed inside the epoxy composition as one integral rigid solid piece with no hollow or air space inside the light (100). Hence the LEDs (10) and drive electronics are sealed for life, and the lights (100) are effectively water proofed with no ingress of dust or moisture. The light (100) can therefore easily pass IP67 certifications tests that require immersion in water up to 1 meter deep.

The top part of the beacon light (100) is provided with a sharp bird spike (13) to prevent birds standing or resting on the beacon light (100) and leave droppings that may dirty the clear LEDs (10) lens surface that can cause reduction of its luminous output. Preferably, a logo (12) is embossed on the epoxy composition (11) at the top of the light (100) next to the bird spike (13).

The vertical part of the light (100) has the LEDs (10) are arranged in circular rows one on top of another. The plastic lens body of the LEDs (10) protrudes out of the encapsulating composition so that the light output can be emitted directly through the LEDs (10) without having to go through a clear or coloured cover as in conventional design. The cover will cause a certain amount of reflection and absorption of light when light passes through the cover medium since no material can have a 100% light transmission. Hence the direct emission of the light without going through the cover medium eliminates this loss and is therefore more efficient maximizing light emission.

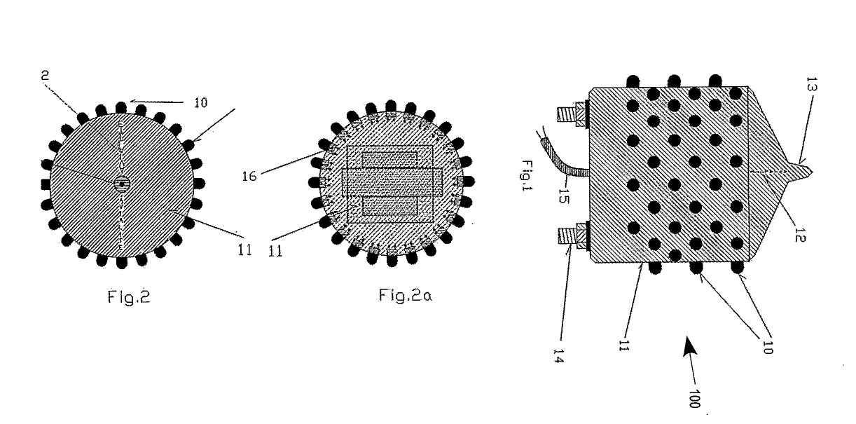

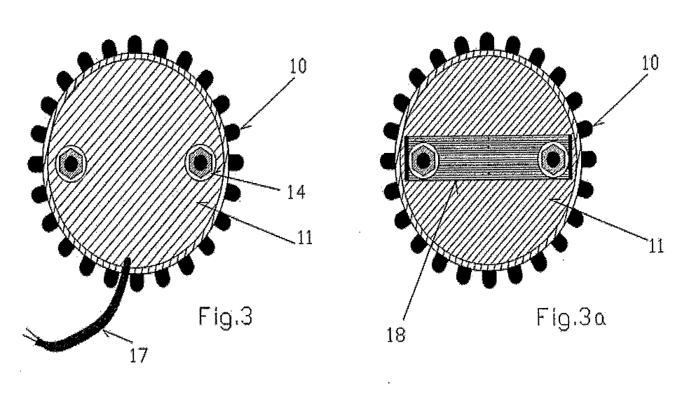

FIG. 2 shows a view of the light (100) seen from the top. FIG. 2a shows the same top view with the part of the LEDs (10) and the electronic control circuits that are fully embedded and sealed in sealing composition (11). The sealing composition (11) may be made of 2 components liquid mixture that stays liquid for about 45 minutes after mixing such as an epoxy based composition or other such materials. The liquid mixture is poured into the prepared moulds containing the LED beacon light (100) complete with its control circuits and lead cable. The sealing composition (11) mixtures hardens or cures in about 5 hours binding all the light (100) circuit components firmly in place after curing exactly as were set before pouring of encapsulating composition and seals the inner part of the LEDs (10) with its electrical leads and the control circuits fully from dust, water and moisture. The shape of the light (100) is formed with correctly designed moulds that fit and hold all the relevant components in place. After the composition has cured the LED beacon light (100) is removed from the two pieces casting mould. The light (100) is now a solid piece with no moving parts and is very compact, and sealed for life from water and moisture. The electronic control circuits can be AC, DC or battery powered.

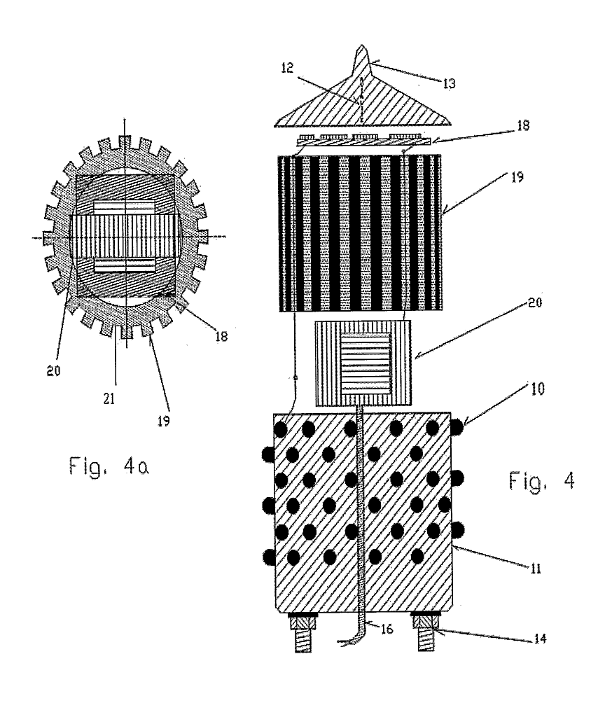

FIG. 3 shows the bottom view of the LED light (100) with mounting bolts and nuts (14) for fixing the lamp to a mounting bracket on Telecommunication towers or on building top. The cable (15) for electrical supply also exits from the bottom of the light (100). As the cable (15) end is also embedded in the sealing composition (11) water and moisture cannot leak into the lamp. FIG. 3a show how the mounting bolts (14) are attached to a metal plate (17) that is fully embedded in the sealing composition (11) as reinforcement for the mounting bolts (14) from external tension forces.

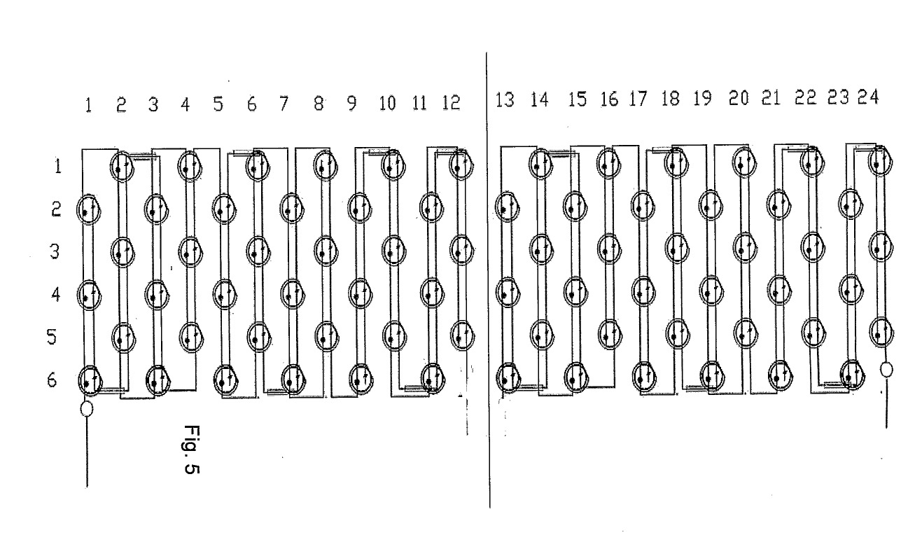

FIG. 4 shows the exploded view of the LED light (100) showing the various internal parts before assembly. This includes the LED assembly, 72 LEDs (10) connected in parallel clusters that are in turn connected in series with elongate conductor such as copper wires, the step down transformer (20) in the case of AC powered lamps and electronic control card (18) for conversion from AC voltage into DC voltage supply to the LEDs (10). A specially designed hollow tube (19) with a plurality of grooves thereon (21) is used to hold and position the LEDs (10) in circular rings and also insulate and hold firm the transformer (20) and electronic control card (18) inside the hollow center of the hollow tube (19). The portions of the LEDs (10) bodies that are to be exposed are inserted into specially designed rubber moulds that have same number of holes as the number of LEDs (10). The rubber mould will serve to cover and seal the part of the LEDs (10) that must not be in contact or embedded in epoxy based composition, this part will appear as exposed part of the LEDs (10) in the finished product. The rubber mould will in turn be fitted into an external rigid casting mould and hold firm the complete lamp assembly with the help of the hollow tube (19) in a specific position in the aforementioned casting external mould cavity that will also form the external shape of the lamp. FIG. 5 shows the perspective view of a cluster of LEDs (10) electrically connected together which are affixed along an elongate conductor, preferably, in a rectangular sinusoidal wave form.

In the foregoing specification, specific embodiments of the present invention have been described. However, one of ordinary skill in the art appreciates that various modifications and changes can be made without departing from the scope of the present invention as set forth in the claims below. For example the light (100) can adopt other physical layouts. The LEDs (10) can be arranged in different horizontal angular spacing with different beam angles. The number of LEDs (10) can be increased or decreased. The size and diameter of the LEDs (10) can be different from 5 mm diameter LEDs (10) shown in this example. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issues.

1. A beacon light (100) for obstacle warning comprising:
an elongated body portion formed into a hollow tube (19);
a plurality of light emitting diodes (LEDs) (10) mounted on the outer surface of the hollow tube (19) and electrically connected together to form a substantially cylindrical array of LEDs (10);
characterized in that
a plurality of grooves (21) are formed axially on the outer surface of the hollow tube for arranging the array of LEDs (10) in a substantially cylindrical and orderly manner; and
the hollow tube and the LEDs (10) being encapsulated with sealing composition (11), wherein at least a part of the lens body of the LEDs (10) protrudes out from the surface of the encapsulation to allow the direct emission of light.

2. A beacon light (100) as claimed in claim 1, further comprising a sharp spike (13) attached at the top part of the sealing composition (11) to prevent flying creatures resting on the beacon light (100) and leave droppings that may contaminate the lens body of the LEDs (10) that can cause reduction of its luminous output.

3. A beacon light (100) as claimed in claim 1, wherein the LEDs (10) are arranged in vertically adjacent rows, each row comprises LEDs (10) which are separated angularly in the horizontal plane.

4. A beacon light (100) as claimed in claim 3, wherein a substantially 15 degree angular offset is applied between the adjacent rows.

5. A beacon light (100) as claimed in claim 1, wherein the LEDs (10) are affixed along an elongate conductor (20) set within the grooves (21) and the surface of the body portion.

6. A beacon light (100) as claimed in claim 5, wherein the elongate conductor (20) is formed in a rectangular sinusoidal wave form.

7. A beacon light (100) as claimed in claim 1, wherein the sealing composition (11) is an epoxy based composition.

8. A beacon light (100) as claimed in claim 1, further comprising mounting bolts and nuts (14) for fixing the beacon light (100) to a mounting bracket on a tower.

9. A beacon light (100) as claimed in claim 8, further comprising a metal plate (17) that is embedded in the sealing composition (11) as reinforcement for the mounting bolts and nuts (14) attached thereto.

10. A beacon light (100) as claimed in claim 1, wherein the elongated body portion is made of polystyrene or other plastic material.
